(19) United States
(12) Patent Application Publication
(10) Pub. No.: US 2012/0246064 A1
(43) Pub. Date: Sep. 27, 2012

(54) CUSTOMER REFUNDS USING PAYMENT SERVICE PROVIDERS

(75) Inventor: Corinna Balkow, Berlin (DE)

(73) Assignee: EBAY, INC., San Jose, CA (US)

(21) Appl. No.: 13/070,236

(22) Filed: Mar. 23, 2011

(51) Int. Cl. G06Q 40/00

(52) U.S. Cl. 705/39

(57) ABSTRACT

A method by which a merchant can establish and advantageously use an account at an online payment service provider for making both payments and refunds to customers so as to minimize overdraft or non-sufficient funds (NSF) occurrences and the attendant delays and loss of customer good will includes providing at least one processor communicating through at least one network, and using the at least one processor and network to receive a refund request, access a user reserve account with an online payment service provider, wherein the reserve account is associated with a regular account of the user with the payment service provider, and processing the refund request from the reserve account.

### BACKGROUND

1. Field of the Invention

This application relates to e-commerce in general, and more particularly, to methods and apparatus for setting up and using merchant-to-customer refund accounts at payment service providers.

2. Related Art

Merchants, especially online sellers of goods or services, often use the services of payment service providers, such as PayPal, for receiving payments from customers made by, e.g., credit cards, debit cards, or where the customer has an account at the service provider, an internal transfer of funds, as well as for making payments to third parties and refunds to customers. Indeed, in some systems, the payment service provider may provide a merchant user with a visual display of the current status of its account, e.g., a web page, detailing, for example, the date, amount and customer identity of each of the payments received to date on behalf of the user. In some such systems, the user has merely to select a “REFUND” button or icon disposed adjacent to that particular payment on the display to effect a timely refund to the customer of any one of these payments.

However, a problem can arise when making refunds to customers if the merchant user's account at the service provider lacks sufficient funds (NSF) to cover a given refund. In such cases, the service provider typically will not process the refund until after the user has “topped up” the account from another source of funds, e.g., a third party bank account of the user. Since the latter process can entail a delay of as much as a week, this can result in a loss of some good will of customers whose refunds are delayed.

Accordingly, what is needed are simple, straightforward and reliable systems by which a user of an online payment service provider can establish and advantageously use an account for both receiving payments from customers and for making payments to third parties and refunds to customers so as to substantially minimize overdraft or non-sufficient funds (NSF) occurrences and the delays and loss of customer good will attendant thereto.

### SUMMARY

In accordance with the present invention, systems are provided by which a user of a payment service provider can establish and use a dedicated reserve account in association with a regular user account for making both payments and customer refunds so as to minimize potential overdraft or non-sufficient funds (NSF) occurrences and the delays and loss of customer good will attendant thereto.

In one example embodiment, a method comprises providing at least one processor communicating through at least one network, and using the at least one processor and network to receive a refund request, access a user reserve account with an online payment service provider, the reserve account being associated with a regular account of the user with the payment service provider, and to process the refund request from the reserve account.

In another embodiment, an apparatus comprises means for receiving a refund request, means for accessing a user reserve account with an online payment service provider, the reserve account being associated with a regular account of the user with the payment service provider, and means for processing the refund request from the reserve account.

In another embodiment, the service provider can suggest to the user the required minimum balance that should be maintained in the account based on a transaction history of the account over a period of time.

A better understanding of the above and other features and advantages of the novel payment receiving, making and refunding systems of the present invention may be obtained from a consideration of the detailed description of some example embodiments thereof presented below, particularly if such consideration is made in conjunction with the several views of the appended drawings, wherein like elements are referred to by like reference numerals throughout.

### BRIEF DESCRIPTION OF THE FIGURES OF THE DRAWINGS

FIG. 1 is process flow diagram of an example embodiment of a method for making payments and refunds in accordance with the present invention; and,

FIG. 2 is functional block diagram of an example embodiment of apparatus for making payments and refunds in accordance with the present invention.

### DETAILED DESCRIPTION

Merchants, including online sellers of goods or services, occasionally need to make refunds to their customers for a variety of reasons. For example, goods delivered to a customer may be defective, the wrong size or color, or simply not of a quality, type or number that the customer expected to receive. In such cases, a resolution of the problem may require the merchant to refund part or all of the purchase price to the customer. As described above, where the merchant uses a payment service provider, this is typically effected rapidly and efficiently through the agency of the service provider, who typically credits the same financial account of the customer from which the original payment was funded, i.e., the same credit, debit, bank or service provider account from which the payment was made.

However, if the merchant user's account at the service provider lacks sufficient funds to cover a given refund, this can present a problem when making refunds to its customers, because, absent another source of funds linked to the user account, the service provider typically will not process the refund until the user tops up the account from another source of funds, e.g., a third party credit card, debit card or bank account. Since the latter process can entail a delay of as much as a week, this delay can result in a loss of good will on the part of the customers whose refunds are delayed.

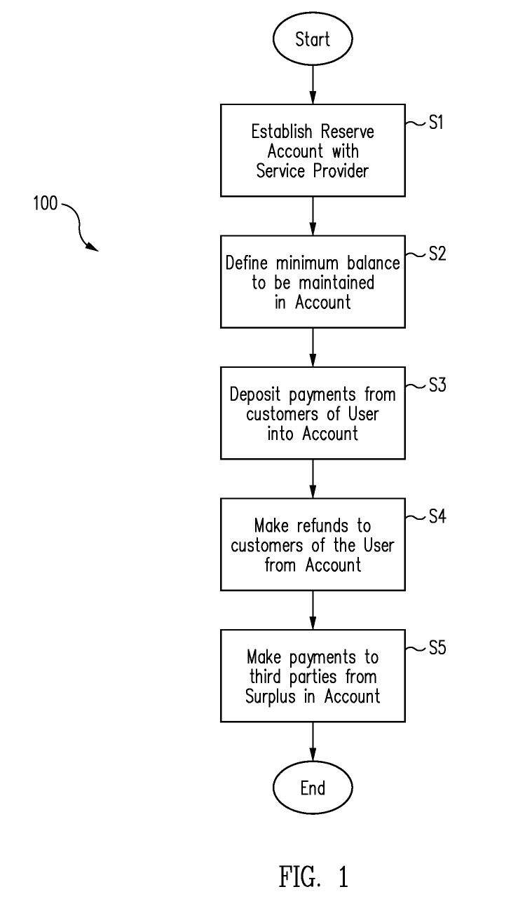

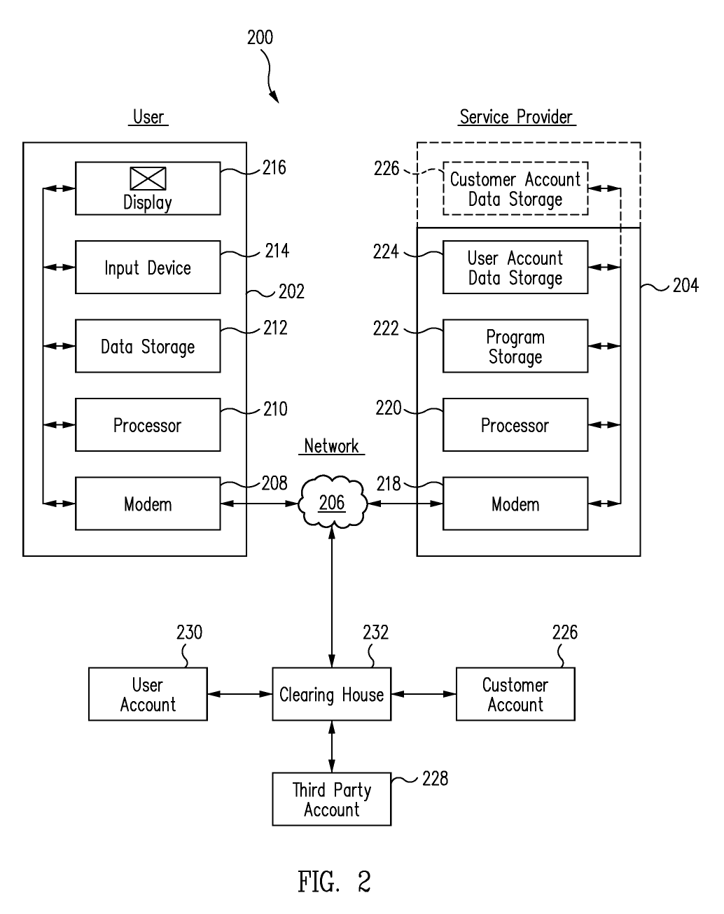

FIGS. 1 and 2 respectively illustrate an example method 100 and apparatus 200 by which a merchant user of a payment service provider can establish and use a reserve account for making both payments and customer refunds in such a way as to minimize potential overdraft or non-sufficient funds (NSF) occurrences and the delays and loss of good will attendant thereto.

As illustrated in FIG. 1, the method 100 begins at step 1 (S1) with establishing a user reserve account at an online payment service provider, such as PayPal or ACH Direct. The account may be of a type typically set up by the service provider on behalf of, e.g., a merchant or small business, to which payments made by customers of the user, typically made in the form of, e.g., credit card or debit card payments, are deposited, and from which payments by the user to third parties are made. It should be noted that this reserve account is a separate account from the user's regular account with the payment provider. The regular account is a conventional account with the payment provider for processing financial transactions for the user, such as receiving and making payments. As discussed herein, the reserve account is primarily used for processing refunds debited from the account. However, as discussed in more detail below, the reserve account may also be used to make payments to the user or to third parties.

Of importance, at S2, the user, the service provider, or both the user and the service provider then establish a minimum balance to be maintained in the account. In new accounts, the amount of the minimum balance may be simply a “best guess” estimate made by the user on the basis of anticipated deposits and refunds to be made to and from the reserve account. However, if the user has developed an actual transaction history over a period of time, the minimum balance is preferably based on that history, and in another embodiment, the service provider may compute and suggest to the user a minimum balance amount that is based on the actual transaction history of the account over a period of time. In another embodiment, the service provider may set the minimum balance for the user, which can be based on different factors, such as the user's return history, both amount and number, a trend of more or less returns by this user, and growth or shrinkage of the user's business over time.

After the minimum balance has been established for the reserve account, the method 100 proceeds at S3 with the service provider depositing payments from customers of the user into the account to fund the account. In another embodiment, the user may fund the reserve account from a user funding source, such as a bank account or credit card. In yet another embodiment, the reserve account may be funded partially by the user and partially by payments received by the service provider from customers of the user.

At S4, the service provider makes refunds to customers of the user from the account at the behest of the user. This may be prompted by the user authorizing or requesting a refund to a customer for a particular amount. The service provider may credit the refund amount to the customer account, such as one established with the service provider, and may debit a corresponding amount, which may include any service charges, from the user reserve account. If the requested refund amount is greater than the balance in the user reserve account, the service provider may handle the request in any number of ways. For example the service provider may request the user to add additional funds into the account, may pull funds from another user funding source, may pull funds from another user account with the service provider, or any combination of the foregoing.

In one embodiment, the reserve account may also be used to make payments to another user account or to third parties at the request of the user. In this case, at S5, the service provider makes payments to third parties on behalf and at the behest of the user from a “surplus” in the account, i.e., the total amount of funds in the account less the required minimum balance thereof. If the requested amount is greater than the surplus, the service provider may process accordingly. For example, the service provider may request the user to add additional funds to the account, pull funds from another user funding source, or pull funds from another user account with the service provider. In addition, if the required minimum balance was determined/set by the user, the user may be given an option of going below the minimum to make the payment. However, if the minimum balance is a true requirement of the service provider, the request may be denied or the remaining amount funded from another source.

By maintaining a preselected minimum balance in the account, particularly one based on the user's actual receipts/refunds history over a period of time, the user may reasonably be assured that the balance in the account will always be greater than or equal to that which might be needed to make refunds to customers immediately, rather than after an account top-up delay that is objectionable to many customers.

In some embodiments, the user may elect to “link” a user credit card, debit card or bank account to the user's regular account and authorize the service provider to automatically fund some or all of the payments made to third parties on behalf of the user from those linked sources. Alternatively or additionally, if the user finds that, over a period of time, the surplus in the reserve account is larger than needed, the user may instruct the service provider to transfer some or all of the surplus to, e.g., a third party bank account of the user, e.g., a savings account. The service provider may also request the user to increase the minimum balance, such as if the amount of refunds or payouts being made from the reserve account over a given period of time are higher than initially anticipated.

FIG. 2 is functional block diagram of an example embodiment of an apparatus 200 for receiving payments and making payments and refunds in accordance with the present invention, e.g., using the method 100 discussed above in connection with FIG. 1. As illustrated in FIG. 2, the apparatus 200 may include a user device 202 and a service provider device 204 connectable to each other for bidirectional data communication with each other by at least one data communication network 206. The network 206 may comprise, for example, the internet.

The user's device 202 may comprise, for example, a personal computer, such as a desktop or laptop computer, a portable tablet computer, a smart phone or a personal digital assistant (PDA), each of a well-known type, and may include a modem 208 for connecting the user to the service provider via the network 206, as well as a processor 210, a data storage device 212, such as a hard disk drive or flash memory, an input device 214, such as a key board, a key pad and/or a mouse or other pointing device, and a display 216, such as a liquid crystal display (LCD), for displaying data to the user useful for, e.g., user account management. For example, the user may employ the user device 202 to establish a reserve account at a payment service provider, associate a minimum balance required to be maintained in the account, direct the service provider to make refunds to customers and payments to third parties from user accounts, and so on.

As further illustrated in FIG. 2, the service provider device 204 may comprise a data server, and may include a modem 218, a processor 220, a program storage device 222, such as a hard drive, a storage device 224 for storing the user regular and reserve accounts data, and optionally, a user customer account data storage device 226. As discussed above, using the service provider device 204, the service provider may, at the user's behest and on its behalf, carry out the instructions of the user to, e.g., receive payments from and make refunds to customers of the user, make payments to third party bank accounts 228, transfer funds from the reserve account surplus to a third party bank account 230 of the user, and so on.

As those of skill in the art will appreciate, where the user and a customer of the user both have established accounts 224 and 226 with the service provider, the service provider can, for example, effect payments and refunds directly between the respective accounts of the two parties “internally,” i.e., without further resort to the network 206.

Alternatively, where the customer account 226 and/or a third party payee account 228 resides at a bank or other financial institution not affiliated with the service provider, the network 206 of the apparatus 200 may comprise an electronic network component, such as the Automated Clearing House (ACH) or the Electronic Payments Network (EPN) and a clearing house 232, that enable the service provider to effect transfers of funds between the user's accounts 224 and the customer account 226 and/or the third party payee accounts 228 electronically via the network 206.

Although the methods and apparatuses of the present invention have been described and illustrated herein with reference to certain specific example embodiments thereof, it should be understood that a wide variety of modifications and variations may be made to these without departing from the spirit and scope of the invention, as defined by the claims appended hereafter and their functional equivalents.

What is claimed is:

1. A method, comprising:
providing at least one processor communicating through at least one network and using the at least one processor and network to
receive a refund request,
access a user reserve account with an online payment service provider, the reserve account being associated with a regular account of the user with the payment service provider, and
process the refund request from the reserve account.

2. The method of claim 1, further comprising using the at least one processor and network to deposit a payment from a customer of the user into the reserve account.

3. The method of claim 1, further comprising using the at least one processor to establish the user reserve account and associate a minimum balance to be maintained therein.

4. The method of claim 3, further comprising using the at least one processor and network to make a payment to a third party on behalf of the user from a surplus in the reserve account equal to the total amount in the account less the minimum balance thereof.

5. The method of claim 4, further comprising using the at least one processor and network to transfer some or all of the surplus in the reserve account to a third party financial account of the user.

6. The method of claim 4, further comprising using the at least one processor and network to fund some or all of the payment made to the third party on behalf of the user from a user credit card, a user debit card or a user bank account.

7. The method of claim 1, wherein the amount of the minimum balance is based on a transaction history of refunds processed on behalf of the user over a period of time.

8. The method of claim 2, wherein the payment from the customer of the user is funded from a customer credit card account, a customer debit card account or a customer account established with the online payment service provider.

9. The method of claim 1, wherein the refund is made to the same customer account from which it was funded.

10. A non-transitory machine-readable medium comprising a plurality of machine-readable instructions which when executed by one or more processors of a server are adapted to cause the server to perform a method comprising:
receiving a refund request;
accessing a user reserve account with an online payment service provider, wherein the reserve account is associated with a regular account of the user with the payment service provider; and,
processing the refund request from the reserve account.

11. The medium of claim 10, wherein the method further comprises establishing the user reserve account and associating a minimum balance to be maintained therein.

12. The medium of claim 10, wherein the method further comprises depositing a payment from a customer of the user into the reserve account,

13. The medium of claim 11, wherein the method further comprises making a payment to a third party on behalf of the user from a surplus in the reserve account equal to the total amount in the account less the minimum balance thereof.

14. The medium of claim 13, wherein the method further comprises transferring some or all of the surplus in the reserve account to a third party financial account of the user.

15. The medium of claim 13, wherein the method further comprises funding some or all of the payment made to the third party on behalf of the user from a user credit card, a user debit card or a user bank account.

16. The medium of claim 11, wherein the amount of the minimum balance is based on a transaction history of refunds processed on behalf of the user over a period of time.

17. The medium of claim 10, wherein the method is at least in part effected using at least one network.

18. The medium of claim 17, wherein the at least one network comprises the internet, the Automated Clearing House (ACH) or the Electronic Payments Network (EPN).

19. An apparatus, comprising:
means for receiving a refund request;
means for accessing a user reserve account with an online payment service provider,
wherein the reserve account is associated with a regular account of the user with the payment service provider; and,
means for processing the refund request from the reserve account.

20. The apparatus of claim 19, further comprising means for depositing a payment from a customer of the user into the reserve account.

21. The apparatus of claim 19, further comprising means for establishing the user reserve account and associating a minimum balance to be maintained therein.

22. The apparatus of claim 21, further comprising means for making a payment to a third party on behalf of the user from a surplus in the reserve account equal to the total amount in the account less the minimum balance thereof.

23. The apparatus of claim 22, further comprising means for transferring some or all of the surplus in the reserve account to a third party financial account of the user.

24. The apparatus of claim 22, further comprising means for funding some or all of the payment made to the third party on behalf of the user from a user credit card, a user debit card or a user bank account.

25. The apparatus of claim 21, further comprising:
means for storing and retrieving transaction history of the reserve account at the service provider; and,
means for basing the minimum balance in the account on the transaction history.
